(19) United States
(12) Patent Application Publication
(10) Pub. No.: US 2018/0035692 A1
(43) Pub. Date: Feb. 8, 2018

(54) ADDITION OF EDIBLE FAT (LIPIDS) TO HAY FOR ENHANCING THE NUTRITIONAL VALUE AND DIGESTIBILITY AND REDUCING THE TOXICITY RISK

(71) Applicant: NORMAN J. SMALLWOOD, PLANO, TX (US)

(72) Inventor: NORMAN J. SMALLWOOD, PLANO, TX (US)

(21) Appl. No.: 15/555,600

(22) PCT Filed: Mar. 4, 2016
(86) PCT No.: PCT/US16/20947

§ 371 Date: Sep. 5, 2017

Related U.S. Application Data
(60) Provisional application No. 62/129,074, filed on Mar. 6, 2015.

(51) Int. Cl. A23K 10/30; A23K 50/10; A23K 20/10; A23K 20/20; A23K 20/174; A23K 20/158

(52) U.S. Cl. CPC A23K 10/30; A23K 20/174; A23K 20/158; A23K 20/10; A23K 20/20; A23K 50/10

(57) ABSTRACT

A method for improving the nutritional value of hay used for livestock feed is disclosed. The methods includes the application of one or more lipids to the hay prior to feeding to animals. Additional components may also be added such as vitamins, minerals, nitrogen, amino acids and the like.

### CROSS-REFERENCE TO RELATED APPLICATIONS

This application claims priority under 35 U.S.C. § 119 to provisional application Ser. No. 62/129,074 filed Mar. 6, 2015, herein incorporated by reference in its entirety.

### FIELD OF THE INVENTION

The present invention relates to nutritional value and digestibility improvement and toxicity reduction of hay for livestock feed by the addition of edible lipids.

### BACKGROUND OF THE INVENTION

Hay is the term covering grass, legumes, or other herbaceous plants that have been cut, dried, bailed or loose stacked, and stored for use as livestock feed. Hay is feed to livestock when growing plants for grazing are not available. The nutritional value, digestibility and health risk of hay varies by type and handling conditions.

Nutritionally, hay is low in metabolizable energy and essential fatty acids. Protein level is low with the exception of legume hay like alfalfa. All kinds of hay have a high fiber content.

Hay-fed livestock are exposed to several health risks. Most kinds of hay are inadequate in essential fatty acid content. Hay exposed to moisture in the handling steps after drying results in the growth of mold. Respiratory impairment from breathing mold dust in the hay is often a problem. With the fiber content including rough stems, the digestibility of hay is troublesome. Digestive track inflammation is problematic, especially for young animals.

It is common to feed hay to livestock hay when pasture grass is not available. Hay alone is nutritionally deficient due to the inadequate content of metabolizable energy from lipids. The lipid deficiency results in insufficient essential fatty acid intake. In most cases, this deficiency is not addressed by providing supplemental feed containing the optimum quantity of lipids. It is well-known that animal growth and fertility is limited by the level of nutrients in the feed available for consumption.

### SUMMARY OF THE INVENTION

The present invention provides a novel method for treating hay with lipids to improve animal nutrition, provide essential fatty acids for health, reduce animal digestive system irritation and inflammation, and ameliorate the mold-dust health problem inherent with hay. Application of the invention offers an attractive financial benefit from animal weight gain and health-problem avoidance.

Lipid treatment of hay not only improves the nutritional value, but ameliorates the rough texture and mold problems. The lubrication and fiber softening effect of lipids adhering to the hay-fiber surface area and penetrating into the stems and leaves significantly improves digestibility. Irritation and inflammation of the digestive system are reduced.

Any of a number of methods may be used to incorporate lipids into hay. A liquid state is required for the best application of lipids. In the case of phospholipids, achieving a fluid state is usually impractical due to the high viscosity. For hay treatment with phospholipids, there are fewer options for application.

Edible lipids for livestock feed comprise both animal and vegetable sources. It includes all states of lipids from crude to fully refined that are classified as edible for animals. Lipid degradation products like free fatty acids, monoglycerides and diglycerides classified as edible are used in animal feed. Complex lipids like phospholipids are included.

Lipids applied to hay soften and lubricate the rough hay fiber, including stems that reduce the irritation and inflammation in the animal digestive system. With the exception of those classified as emulsifiers (monoglycerides, diglycerides and phospholipids), lipids applied to properly dried hay during the baling or stacking operations provide moisture protection against bio-gradation and mold growth. Hay treatment by any kind of lipid before feeding to livestock minimizes mold dust that causes respiratory problems.

The quantity and type of lipid added to the hay can determined by considering the type of hay, quality of hay including the moisture content, storage conditions provided for the hay before feeding, the weight gain objective for the animals being fed, and the financial benefit to be gained. For treatment of hay immediately before feeding, the quantity of lipid added can best determined by what is needed to control the mold dust. The minimum amount of lipid added should be not less than 2% by weight.

Lipid selection decisions are dictated by economics, availability, and cultural and/or religious restrictions. Lipid melting point is another consideration. High melting point lipids require heating to liquefy before application to the hay.

### BRIEF DESCRIPTION OF THE FIGURES

FIG. 1 is a flow chart illustrating the current method for feeding hay to livestock.

FIG. 2 is a flow chart illustrating the general method of treating hay with lipids for feeding livestock.

FIG. 3 is a flow chart illustrating specific options for treating hay with lipids.

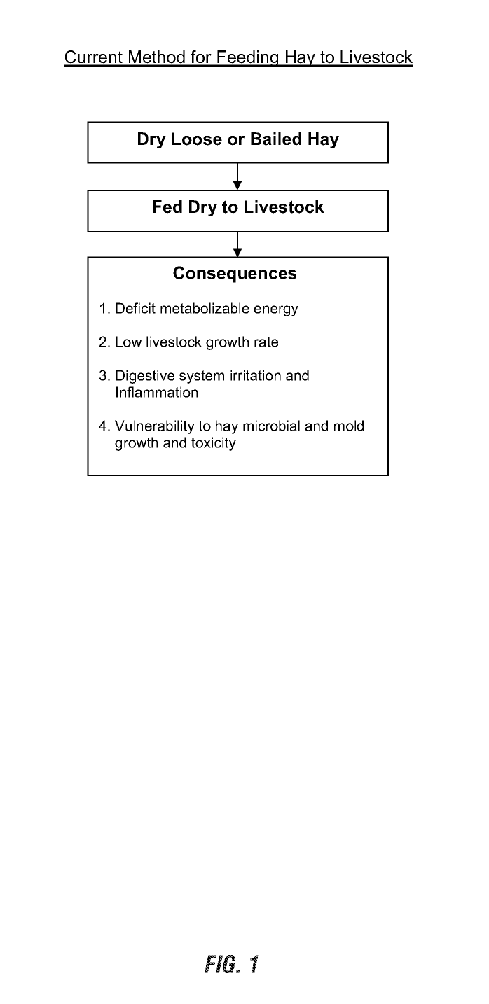

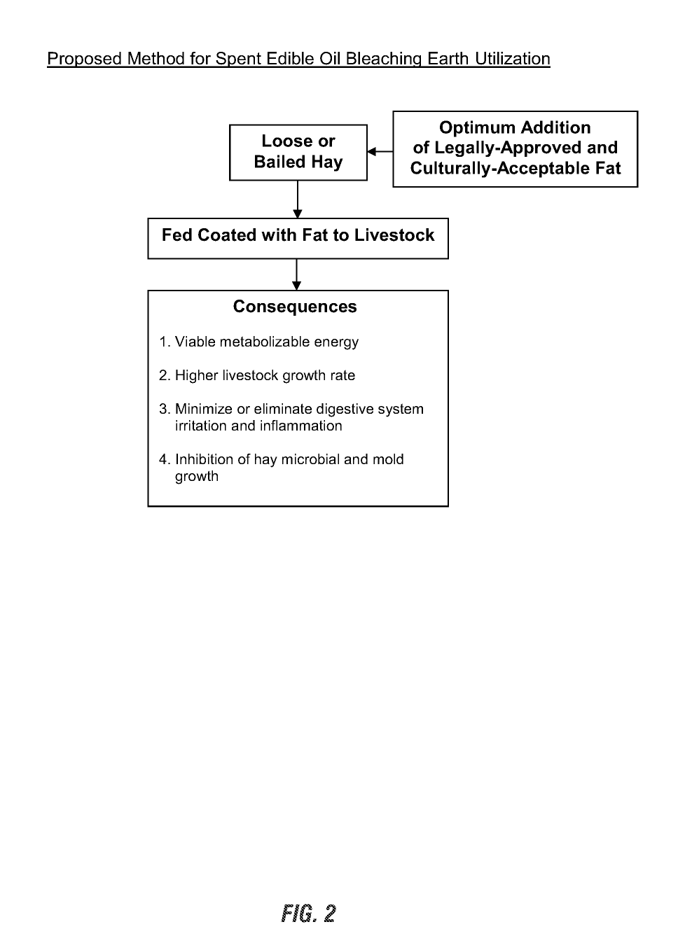

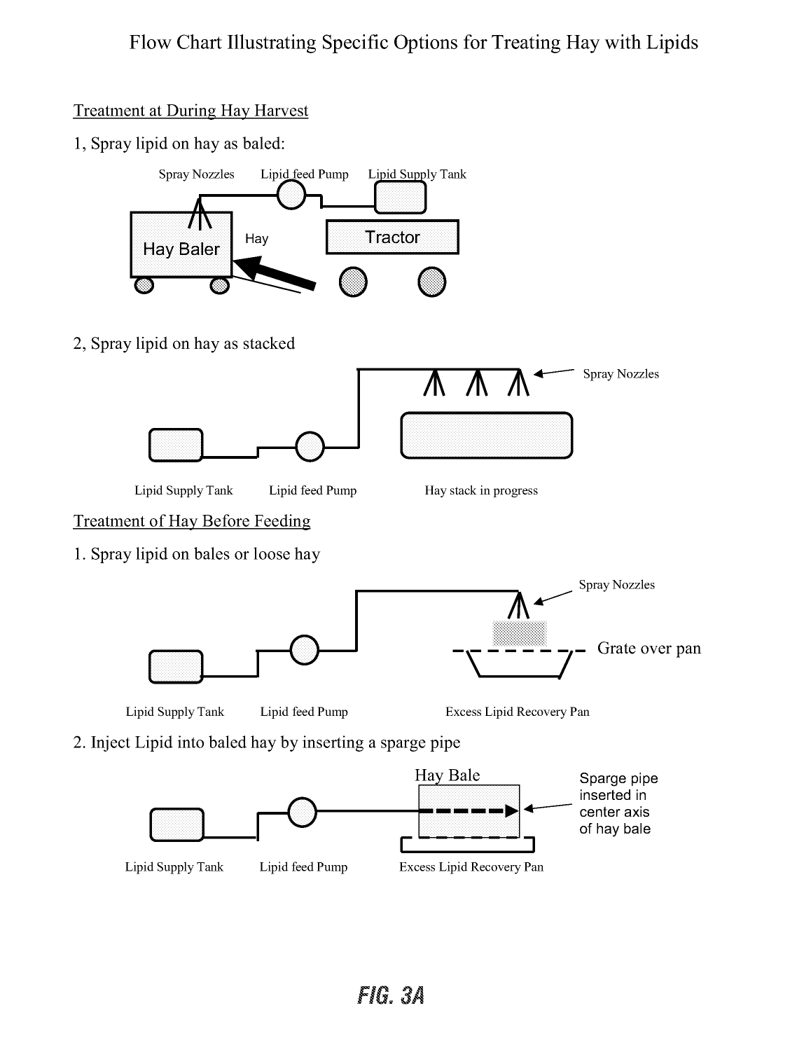

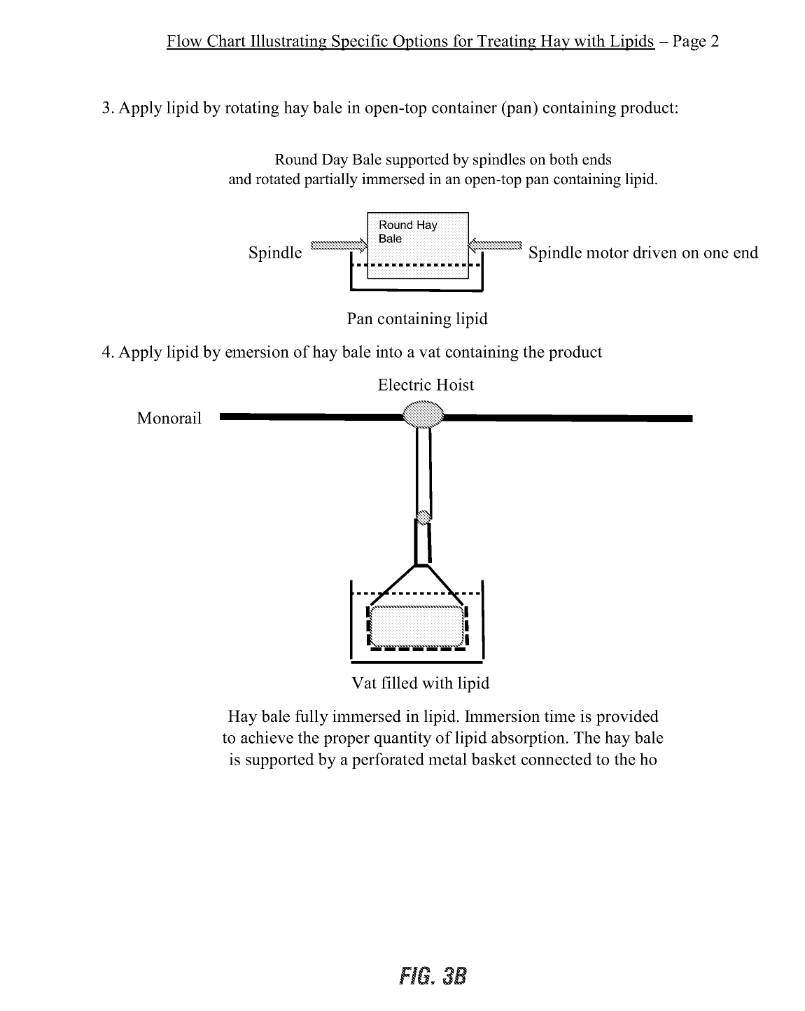

### DETAILED DESCRIPTION OF THE PREFERRED EMBODIMENTS

The embodiments of this invention are not limited to particular hay (forage) types and composition and lipid compositions and methods of use thereof, which can vary and are understood by skilled artisans. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in their SI accepted form. Numeric ranges recited within the specification are inclusive of the numbers defining the range and include each integer within the defined range.

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below. The term “about,” as used herein, refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

The terms “weight percent,” “wt-%,” “wt %” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### Ingredients

Hay

Commonly used plants for hay include mixtures of grasses such as ryegrass (Lolium species), timothy, brome, fescue, Bermuda, orchard grass, and other species, depending on region. Hay may also include legumes, such as alfalfa (lucerne) and clovers (red, white and subterranean). Legumes in hay are ideally cut pre-bloom. Other pasture forbs are also sometimes a part of the mix, though these plants are not necessarily desired as certain forbs are toxic to some animals.

Oat, barley, and wheat plant materials are occasionally cut green and made into hay for animal fodder; however they are more usually used in the form of straw, a harvest byproduct where the stems and dead leaves are baled after the grain has been harvested and threshed. Straw is used mainly for animal bedding. Although straw is also used as fodder, particularly as a source of dietary fibers, it has lower nutritional value than hay.

Lipids

Suitable lipid sources for the composition of the present disclosure may be any known or used in the art, including but not limited to, animal sources, e.g., milk fat, butter, butter fat, egg yolk lipid; marine sources, such as fish oils, marine oils, single cell oils; vegetable and plant oils, such as corn oil, canola oil, sunflower oil, soybean oil, palm olein oil, coconut oil, high oleic sunflower oil, evening primrose oil, rapeseed oil, olive oil, flaxseed (linseed) oil, cottonseed oil, high oleic safflower oil, palm stearin, palm kernel oil, wheat germ oil; medium chain triglyceride oils and emulsions and esters of fatty acids; and any combinations thereof. Examples include, but are not limited to, fatty acids (e.g., stearic, palmitic, oleic, linoleic, and lauric acid), complex lipids (e.g., phospholipids), and monoglycerides and diglycerides. Sources of edible fats may include, but are not limited to, coconut oil, corn oil, cottonseed oil, fish oil, olive oil, palm oil, sesame oil, soybean oil, canola oil, sunflower seed oil, tallow, greases, beef fat, restaurant fats, and mixtures thereof.

### Optional Ingredients

Lipids are excellent carriers for some feed supplements including vitamins. Examples of such vitamins include, but are not limited to, vitamins A, E, K, and the B group vitamins.

Optionally, dietary nitrogen may be included in the lipids. Optional dietary nitrogen sources include, but are not limited to, ammonia, ammonium polyphosphate, animal protein products, oilseed meals, synthetic amino acids, and urea.

Optionally, various vitamins may be added to the mixture.

Optionally, various trace minerals and elements may be added to the mixture. Examples of such trace minerals and elements include, but are not limited to, cobalt sulfate, copper sulfate, ferrous sulfate, ferrous oxide, iodines, manganese sulfate, potassium iodate, selenium and its compounds, sulphur, zinc oxide, and zinc sulfate, etc.

Optionally, various drugs, medicaments, insecticides, enzymes, antimicrobials, probiotics and the like may be added to the mixture.

Treatment of Hay with Lipids

The preferred and most beneficial method for treating hay with lipids is by use of a spray system installed on each baler used. Spray nozzles are installed at the optimum location to uniformly distribute the lipid to the hay on entry to the baler. The nozzle type, number and location is determined on the basis of the specific bailer design. Lipid is fed to the nozzles by means of piping and hose from a pump driven by a variable speed motor. The motor speed is adjusted to deliver the specified quantity of lipid to the hay. A lipid supply tank attached to the baler or the tractor pulling the baler is piped to the feed pump suction. This method is not applicable to lipids classified as emulsifiers like phosphatides, monoglycerides and diglycerides.

For loose hay that is stacked, lipid is sprayed on top of each layer of hay added (about 18-inch-thick layer). The spray system may be a handheld spray nozzle or series of nozzles mounted on a suspended rack that can be posited above the haystack as layers of hay are added. A supply tank, piping, hose, pump with variable-speed drive are provided at the stacking site to feed lipid to the spraying nozzle(s). This method is not applicable to lipids classified as emulsifiers like phosphatides, monoglycerides and diglycerides.

The advantage of treating hay with non-emulsifying lipids immediately after cutting and drying is to waterproof the hay during the time it is exposed to rain or snow. This minimizes bio-degradation and mold growth. The additional advantage is long exposure of the lipids to the hay for the softening effect to improve digestibility.

Baled or loose hay can be treated with lipids just prior to feeding. Lipid can be applied to bailed or loose hay by standard spray apparatus. To avoid lipid waste, each bale or lot of loose hay should be placed in a large pan during the spraying operation. Lipid draining of the hay collects in the pan for reuse. This method is not applicable to the phosphatide class of lipids because of the high viscosity.

Lipid can be injected into round bales by inserting a sparge pipe into the center axis. Using a high pressure pump, lipid is distributed in the hay uniformly through the sparge pipe nozzles. The inserted end of the sparge pipe is closed with a conical cap to facilitate penetration. This method is not applicable to the phosphatide class of lipids because of the high viscosity.

For round hay bales, lipid can be applied, by rotating the bale in a pan containing the specified quantity of lipid. After the specified quantity of lipid has been absorbed by the rotating bale, the bale is lifted up above the pan and placed on a drainage rack. Lipid draining from the bale flows back to the pan for use in the next application. This method is applicable to the phosphatide class of lipids that have a high viscosity.

Square (rectangular) bales can be treated with lipid by emersion in a vat of lipid for sufficient time to absorb the specified quantity. The treated bale is lifted out of the vat and placed on a rack to enable free lipid to drain back into the vat for further use. This method is applicable to the phosphatide class of lipids that have a high viscosity.

For high-melting-point lipids, heat exchange capability must be included in the treatment systems to liquefy the lipid before use.

### Livestock Animals

Any grazing animal that is fed hay can be fed the animal feed according to the invention, this includes animals such as cattle, horses, goats, and sheep. This may also include smaller animals such as rabbits and guinea pigs. The hay may be fed at any time during the animal's life and in any amount sufficient for traditional grazing applications.

### EXAMPLE 1

To validate the invention, feeding tests were conducted using 10 six-month old weaned calves over a period of 60 days. Five calves were fed hay without lipid treatment. Five calves were fed with hay from the same source with treatment of 3% by weight lipid (PBSY cottonseed oil). All of the caves were given with the same salt and mineral supply. The results of the test is outlined as follows:

### Untreated-Hay Feeding Results

Average Daily Gain (ADG): 2.1 pounds

Body Condition Score (BCS): Moderate (5)

### Lipid-Treated-Hay Feeding Results

Average Daily Gain (ADG): 2.6 pounds

Body Condition Score (BCS): Very Good (7)

Lipid-Feed Conversion Ratio: 1 to 0.93

What is claimed is:

1. A method for improving the nutritional value and reducing the health risk of hay for livestock feed comprising;
treating hay with one more lipids prior to feeding to said livestock.

2. The method of claim 1 wherein said treating comprises: adding lipid to hay a minimum amount of about 2% by weight; wherein the amount of the hay component is about 98% by weight.

3. The method of claim 1, wherein the hay includes one or more of the following: grass, legumes, pasture forbs, oats, barley, wheat, and/or straw.

4. The method of claim 1, wherein the grass includes one or more of: ryegrass (Lolium species), timothy, brome, fescue, Bermuda, and/or orchard grass.

5. The method of claim 3 wherein said legumes include one or more of the following: alfalfa (lucerne), and/or clover (red, white and subterranean).

6. The method of claim 5 wherein said legumes are cut pre-bloom.

7. The method or claim 3 wherein said oat, barley, and wheat plant are cut green and then dried.

8. The method of claim 3 wherein said hay includes straw that has been harvested.

9. The method of claim 1, wherein the lipid component includes one or more of the following: fatty acids, complex lipids, monoglycerides, diglycerides, and/or edible fats.

10. The method of claim 9 wherein the lipid component is an edible fat.

11. The method of claim 10 wherein said edible fat includes one or more of the following: coconut oil, corn oil, cottonseed oil, fish oil, olive oil, palm oil, sesame oil, soybean oil, canola oil, sunflower seed oil, tallow, greases, beef fat, restaurant fats, and mixtures thereof.

12. The method of claim 9, wherein the lipid component is a fatty acid.

13. The method of claim 12 wherein said fatty acid includes one or more of: stearic acid, palmitic acid, oleic acid, linoleic acid, and/or lauric acid.

14. The method of claim 9 where said lipid component includes a complex lipids.

15. The method of claim 14 wherein said complex lipid is a phospholipid.

16. A composition made by the method of claim 1.

17. A feed composition comprising;
lipid treated hay wherein said composition includes a minimum of about 2% by weight of lipid.

18. The feed composition of claim 17 further comprising a vitamin.

19. The feed composition of claim 18 wherein said vitamin is one or more of vitamin A, vitamin E, vitamin K, and the B group vitamins.

20. The feed composition of claim 17 further comprising nitrogen.

21. The feed composition of claim 20 wherein nitrogen is from a source of one or more of ammonia, ammonium polyphosphate, animal protein products, oilseed meals, synthetic amino acids, and urea.

22. The feed composition of claim 17 further comprising minerals and/or elements.

23. The feed composition of claim 22 where said minerals and/or elements include one or more of: cobalt sulfate, copper sulfate, ferrous sulfate, ferrous oxide, iodines, manganese sulfate, potassium iodate, selenium and its compounds, sulphur, zinc oxide, and/or zinc sulfate.

24. The composition of claim 17 further comprising one or more of the following: drugs, medicaments, insecticides, enzymes, antimicrobials, probiotics and the like

25. A method for producing a hay feed product with improved nutritional value and reduced health risks comprising
treating hay with one more lipids.

26. The method claim 25 wherein said treating comprises;
spraying said hay with lipids during baling of hay.

27. The method claim 25 wherein said treating comprises;
spraying said hay with lipids during hay stacking.

28. The method of claim 25 wherein said treating comprises;
applying of lipid to individual hay bales.

29. The method of claim 25 wherein said treating comprises;
spraying loose hay with lipids by a spraying system.

30. The method claim 25 wherein said treating comprises;
injecting hay bales with lipids by use of a sparge pipe inserted in a hay bale.

31. The method of claim 26 wherwin said treating comprises;
rotating round hay bales, partially submerged, in an open container containing lipids.

32. The method of claim 26 wherein said treating comprises;
emersing hay bales in a vat filled with lipids.

33. A method of improving the health of livestock comprising:
treating hay with lipids, to form a lipid treated animal feed product and thereafter;
feeding said lipid treated animal feed product to livestock.

34. The method of claim 33 wherein said livestock is an animal selected from the group comprising: cattle, horses, goats, and sheep.
